(19) United States
(12) Patent Application Publication
(10) Pub. No.: US 2025/0266462 A1
(43) Pub. Date: Aug. 21, 2025

(54) OXIDE SOLID ELECTROLYTE, COATED ACTIVE MATERIAL, BATTERY, AND METHOD FOR PRODUCING COATED ACTIVE MATERIAL

(71) Applicant: Toyota Jidosha Kabushiki Kaisha, Toyota-shi (JP)

(72) Inventor: Masaru KUBOTA, Okazaki-shi (JP)

(73) Assignee: Toyota Jidosha Kabushiki Kaisha, Toyota-shi (JP)

(21) Appl. No.: 19/025,330

(22) Filed: Jan. 16, 2025

(30) Foreign Application Priority Data
Feb. 15, 2024 (JP) 2024-020911

(51) Int. Cl. H01M 4/62; H01M 4/36; H01M 10/0562

(52) U.S. Cl. CPC H01M 4/628; H01M 4/366; H01M 10/0562; H01M 2300/0071

(57) ABSTRACT

The present disclosure relates to an oxide solid electrolyte, a coated active material, a battery, and a method for producing a coated active material. In the present disclosure, the oxide solid electrolyte containing an Li element, a B element, a P element, and an O element and containing a three-coordinated boron having a coordination number of three is provided.

### CROSS-REFERENCE TO RELATED APPLICATION

This application claims priority to Japanese Patent Application No. 2024-020911 filed on Feb. 15, 2024. The disclosure of the above-identified application, including the specification, drawings, and claims, is incorporated by reference herein in its entirety.

### BACKGROUND

### 1. Technical Field

The present disclosure relates to an oxide solid electrolyte, a coated active material, a battery, and a method for producing a coated active material.

### 2. Description of Related Art

In recent years, the development of a battery has been actively achieved. For example, in the automobile industry, a battery used for a battery electric vehicle (BEV), a plug-in hybrid electric vehicle (PHEV), or a hybrid electric vehicle (HEV) has been developed. In addition, it has been known that a surface of an electrode active material used for the battery is coated with a coating layer.

For example, Japanese Unexamined Patent Application Publication No. 2023-136753 (JP 2023-136753 A) discloses composite particles including positive electrode active material particles and a coating film which coats at least a part of a surface of the positive electrode active material particles and contains a phosphorus compound. Furthermore, J P 2023-136753 A discloses that the composite particles are produced by mixing the positive electrode active material particles with an aqueous coating solution (an aqueous coat solution) containing phosphorus, and drying the mixture.

### SUMMARY

A coated active material in which a coating layer is provided on a surface of an electrode active material has been studied. In addition, a solid electrolyte has been considered as a material for the coating layer. The coating layer is expected to function as a protective layer having favorable ion conductivity and suppressing deterioration of the electrode active material. Therefore, it is desirable that the solid electrolyte used for the coating layer exhibits favorable chemical stability and has favorable ionic conductivity.

The present disclosure has been made in view of the above circumstances, and an object thereof is to provide an oxide solid electrolyte which exhibits favorable chemical stability and has favorable ionic conductivity.

A first aspect of the present disclosure relates to an oxide solid electrolyte containing an Li element, a B element, a P element, and an O element. The oxide solid electrolyte contains a three-coordinated boron having a coordination number of three.

In the oxide solid electrolyte according to the first aspect of the present disclosure, the oxide solid electrolyte contains a four-coordinated boron having a coordination number of four, and when a peak area of the three-coordinated boron is denoted by Sa and a peak area of the four-coordinated boron is denoted by Sb, the peak areas being obtained by NMR measurement of the oxide solid electrolyte, a proportion Sa/(Sa+Sb) of the peak area Sa with respect to a sum of the peak area Sa and the peak area Sb may be 1% or more.

In the oxide solid electrolyte according to the first aspect of the present disclosure, the proportion Sa/(Sa+Sb) may be 45% or less.

In the oxide solid electrolyte according to the first aspect of the present disclosure, the proportion Sa/(Sa+Sb) may be 3% or more and 37% or less.

In the oxide solid electrolyte according to the first aspect of the present disclosure, a proportion Li/(B+P) of the Li element with respect to a total of the B element and the P element may be 0.10 or more and 1.20 or less.

In the oxide solid electrolyte according to the first aspect of the present disclosure, an ionic conductivity at 25° C. may be 1.50×10⁻⁹ S/cm or more.

In the oxide solid electrolyte according to the first aspect of the present disclosure, an average particle diameter D₅₀ of the oxide solid electrolyte may be 3.0 μm or more and 8.0 μm or less.

A second aspect of the present disclosure relates to a coated active material including an electrode active material and a coating layer which coats the electrode active material. The coating layer contains the oxide solid electrolyte described above.

In the coated active material according to the second aspect of the present disclosure, the electrode active material may be an oxide active material.

In the coated active material according to the second aspect of the present disclosure, the oxide active material may be at least one of lithium nickel cobalt aluminum oxide, lithium nickel cobalt manganese oxide, and lithium nickel cobalt manganese aluminum oxide.

In the coated active material according to the second aspect of the present disclosure, the electrode active material may include a negative electrode active material. The negative electrode active material may be an Si-based active material. The Si-based active material may have a clathrate type I crystalline phase or a clathrate type II crystalline phase.

A third aspect of the present disclosure relates to a battery including a positive electrode active material layer, a negative electrode active material layer, and an electrolyte layer disposed between the positive electrode active material layer and the negative electrode active material layer. At least one of the positive electrode active material layer and the negative electrode active material layer contains a coated active material including an electrode active material and a coating layer which coats the electrode active material. The coating layer contains the oxide solid electrolyte described above.

In the battery according to the third aspect of the present disclosure, the positive electrode active material layer may contain the coated active material.

In the battery according to the third aspect of the present disclosure, the battery may be a solid-state battery.

A fourth aspect of the present disclosure relates to a method for producing a coated active material including an electrode active material and a coating layer which coats the electrode active material, the method for producing the coated active material including preparing the oxide solid electrolyte described above, and forming the coating layer by coating the electrode active material with the oxide solid electrolyte by a dry process. The preparing includes a precursor producing treatment of producing a powdery precursor of the oxide solid electrolyte containing an Li element, a B element, a P element, and an O element, and a firing treatment of firing the precursor at a temperature of 450° C. or lower.

In the method according to the fourth aspect of the present disclosure, in the firing treatment, the precursor is fired at a temperature of 120° C. or higher.

In the present disclosure, it is possible to provide an oxide solid electrolyte which exhibits favorable chemical stability and has favorable ionic conductivity.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a schematic cross-sectional view illustrating a coated active material according to the present disclosure;

FIG. 2 is a schematic cross-sectional view illustrating a battery according to the present disclosure;

FIG. 3 is a flowchart illustrating a method for producing a coated active material according to the present disclosure;

FIG. 4 is results of NMR (solid ¹¹B-MNR) in Examples and Comparative Examples;

FIG. 5 is results of NMR (solid ³¹P-MNR) in Examples and Comparative Examples; and

FIG. 6 is a result of NMR (solid ¹¹B-MNR) in Example 4.

### DETAILED DESCRIPTION OF EMBODIMENTS

Hereinafter, the oxide solid electrolyte, the coated active material, the battery, and the method for producing a coated active material in the present disclosure will be described in detail. Figures shown below are schematically shown, and the size and shape of each part are appropriately exaggerated for easy understanding.

### A. Oxide Solid Electrolyte

The oxide solid electrolyte according to the present disclosure is an oxide solid electrolyte containing an Li element, a B element, a P element, and an O element, the oxide solid electrolyte containing a boron (three-coordinated B) having a coordination number of three.

Since the oxide solid electrolyte according to the present disclosure contains an Li element, a B element, a P element, and an O element, and contains the three-coordinated B, the oxide solid electrolyte exhibits favorable chemical stability and has favorable ionic conductivity. In the present disclosure, the chemical stability means oxidation resistance.

It has been known that an oxide solid electrolyte containing an Li element, a B element, a P element, and an O element (LBPO) is a chemically stable solid electrolyte. On the other hand, there is room for further improvement in ionic conductivity. Meanwhile, the oxide solid electrolyte according to the present disclosure contains the three-coordinated B, and thus has favorable ionic conductivity. The oxide solid electrolyte usually contains a boron (four-coordinated B) having a coordination number of four. The four-coordinated B is chemically more stable than the three-coordinated B. In the regard, the present inventors have found that, unexpectedly, when the oxide solid electrolyte contains the three-coordinated B, the ionic conductivity is further improved. The three-coordinated B is chemically less stable than the four-coordinated B, but can exist in a metastable state. Here, the reason why the ionic conductivity is further improved is not clear, but it is presumed that a slight strain occurs in a crystal structure of the oxide solid electrolyte, and a space where carrier ions such as Li ions can move is increased. In an academic paper, the oxide solid electrolyte (Li-doped BPO₄) containing an Li element, a B element, a P element, and an O element is disclosed; however, as described in Examples later, such an oxide solid electrolyte usually does not contain the three-coordinated B.

The oxide solid electrolyte according to the present disclosure contains an Li element, a B element, a P element, and an O element. Furthermore, the oxide solid electrolyte contains a boron (three-coordinated B) having a coordination number of three.

The presence of the three-coordinated B can be confirmed, for example, by NMR (solid ¹¹B-NMR). The three-coordinated B has a peak top in a range of, for example, 15 ppm±3 ppm.

In addition, the oxide solid electrolyte according to the present disclosure may contain a boron (four-coordinated B) having a coordination number of four.

The presence of the four-coordinated B can be confirmed, for example, by NMR (solid ¹¹B-NMR). The B element which is four-coordinated has a peak top in a range of, for example, −3 ppm±5 ppm.

In addition, when the oxide solid electrolyte contains the three-coordinated B and the four-coordinated B described above, a peak area of the three-coordinated B is denoted by Sa and a peak area of the four-coordinated B is denoted by Sb, which are obtained by NMR measurement of the oxide solid electrolyte. In the case, a proportion (Sa/(Sa+Sb)) of the Sa with respect to the sum of the Sa and the Sb is, for example, 1% or more, and may be 3% or more, 5% or more, 10% or more, or 15% or more. On the other hand, the Sa/(Sa+Sb) is, for example, 45% or less, and may be 40% or less, 37% or less, 30% or less, or 20% or less.

A proportion of the Li element in the oxide solid electrolyte is not particularly limited, and is, for example, 20 mol % or more and 50 mol % or less. A proportion of the B element in the oxide solid electrolyte is not particularly limited, and is, for example, 5 mol % or more and 15 mol % or less. A proportion of the P element in the oxide solid electrolyte is not particularly limited, and is, for example, 5 mol % or more and 15 mol % or less. The proportion of each element can be calculated, for example, by inductively coupled plasma (ICP) analysis.

A proportion (molar proportion; Li/(B+P)) of the Li element with respect to the total of the B element and the P element is, for example, 0.10 or more, may be 0.30 or more, and may be 0.50 or more. On the other hand, the Li/(B+P) is, for example, 1.20 or less, and may be 1.00 or less or 0.80 or less.

In addition, a proportion of the O element can be obtained as an oxygen concentration, for example, by a heat melting method. The oxygen concentration of the oxide solid electrolyte according to the present disclosure, obtained by the heat melting method, is, for example, 45% by weight or more and 60% by weight or less. In addition, a molar ratio of the O element in the oxide solid electrolyte is not particularly limited, but is, for example, 30 mol % or more and 60 mol % or less.

In addition, the oxide solid electrolyte may contain, as an impurity element, an element other than the Li element, the B element, the P element, and the O element described above. Examples of the impurity element include Na. A proportion (mol %) of the impurity element is preferably small to an extent that the function of the oxide solid electrolyte according to the present disclosure is not impaired.

The oxide solid electrolyte is typically in a particulate form. An average particle diameter (D₅₀) of the oxide solid electrolyte is, for example, 0.1 μm or more, and may be 0.5 μm or more, 1.0 μm or more, 3.0 μm or more, or 4.0 μm or more. On the other hand, the D₅₀ is, for example, 10.0 μm or less, may be 8.0 μm or less, may be 6.0 μm or less, and may be 5.0 μm or less. In addition, an average particle diameter (D₉₀) of the oxide solid electrolyte is not particularly limited, but is, for example, 2.0 μm or more. The D₅₀ refers to a 50% cumulative particle diameter in a volume-based particle size distribution measured by a laser diffraction-type particle size distribution measuring device. In addition, the D₉₀ corresponds to a particle diameter corresponding to a cumulative 90% by volume from a small particle side, measured by the laser diffraction-type particle size distribution measuring device.

The ionic conductivity of the oxide solid electrolyte at 25° C. is, for example, 1.5×10⁻⁹ S/cm or more, and may be 2.0×10⁻⁹ S/cm or more, 5.0×10⁻⁹ S/cm or more, 1.0×10⁻⁸ S/cm or more, or 1.0×10⁻⁷ S/cm or more. On the other hand, the ionic conductivity is, for example, 1.0×10⁻⁶ S/cm or less.

The oxide solid electrolyte may be crystalline or amorphous. The amorphous state means that a halo peak (a broad peak in a halo pattern) is confirmed in XRD measurement using a CuKα ray. When the oxide solid electrolyte is crystalline, examples of the observed crystalline phase includes Li₃PO₄.

A density (specific gravity) of the oxide solid electrolyte is not particularly limited, and is, for example, 1.50 g/cm³ or more and 3.00 g/cm³ or less. The specific gravity can be obtained, for example, by a gas replacement method using He gas.

### B. Coated Active Material

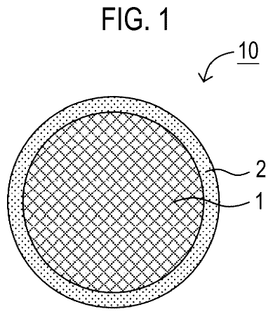

FIG. 1 is a schematic cross-sectional view illustrating a coated active material according to the present disclosure. A coated active material 10 shown in FIG. 1 includes an electrode active material 1, and a coating layer 2 which coats the electrode active material 1. In addition, in the coated active material 10, the coating layer 2 contains the oxide solid electrolyte.

The coated active material according to the present disclosure includes a coating layer containing the oxide solid electrolyte, and thus is chemically stable and has favorable ionic conductivity.

### 1. Electrode Active Material

The electrode active material is not particularly limited as long as it is an active material generally used in a battery. Examples of the electrode active material include an oxide active material. Examples of the oxide active material include lithium nickel cobalt aluminum oxide (NCA), lithium nickel cobalt manganese oxide (NCM), and lithium nickel cobalt manganese aluminum oxide (NCMA).

Examples of a formulation of the lithium nickel cobalt aluminum oxide (NCA) include LiNiₓCo_{y}Al₂O₂ (0.80≤x, 0<y, 0<z, x+y+z=1). x may be 0.85 or more, or may be 0.90 or more. y is, for example, 0.19 or less. z is, for example, 0.10 or less.

Examples of a formulation of the lithium nickel cobalt manganese oxide (NCM) include LiNiₐCo_{b}Mn_{c}O₂ (0.80≤a, 0<b, 0<c, a+b+c=1). a may be 0.85 or more, or may be 0.90 or more. b is, for example, 0.19 or less. c is, for example, 0.10 or less.

Examples of a formulation of the lithium nickel cobalt manganese aluminum oxide (NCMA) include LiNi_{α}Co_{β}Mn_{γ}Al_{δ}O₂ (0.80≤α, 0<β, 0<γ, 0<δ, α+β+γ+δ=1). α may be 0.85 or more, or may be 0.90 or more. β is, for example, 0.19 or less. γ is, for example, 0.08 or less. σ is, for example, 0.08 or less.

In addition, examples of the oxide active material also include lithium titanate such as Li₄Ti₅O₁₂, and SiO₂. In addition, examples of the electrode active material also include a metal such as Si and an alloy.

The electrode active material may have a predetermined crystal structure. The crystal structure is not particularly limited, and examples thereof include a rock salt layer structure, a spinel structure, and an olivine structure.

The coated active material may contain one kind of the electrode active material, or may contain two or more kinds of the electrode active materials.

A shape of the electrode active material is usually in a particulate form. The average particle diameter D₅₀ of the electrode active material is, for example, 100 nm or more, and may be 1 μm or more or 5 μm or more. On the other hand, the average particle diameter D₅₀ of the electrode active material is, for example, 50 μm or less, and may be 20 μm or less. The average particle diameter D₅₀ is as described above.

### 2. Coating Layer

The coating layer coats the electrode active material, and contains the oxide solid electrolyte. The oxide solid electrolyte is the same as described in “A. Oxide Solid Electrolyte”.

A coating rate is not particularly limited, but a higher coating rate is preferable. The coating rate is, for example, 50% or more, and may be 60% or more or 75% or more. On the other hand, the coating rate may be 100%, or may be less than 100%. The coating rate may be 95% or less, 90% or less, or 80% or less. The coating rate can be obtained, for example, by observation with a scanning electron microscope (SEM). In addition, the coating rate can be calculated based on X-ray photoelectron spectroscopy (XPS) measurement. In the XPS measurement, an element ratio is calculated from an intensity ratio of each main element, and the coating rate can be obtained as a proportion of elements contained in the coating layer with respect to the total of elements contained in the electrode active material and the elements contained in the coating layer.

A thickness of the coating layer is not particularly limited, and is, for example, 1 nm or more and 100 nm or less, 5 nm or more and 50 nm or less, or 10 nm or more and 30 nm or less. The thickness of the coating layer is obtained, for example, as an average value of thicknesses of a plurality of samples (for example, 100 or more samples) observed by a scanning electron microscope (SEM) or a transmission electron microscope (TEM).

The coating layer may directly coat the electrode active material. On the other hand, the coating layer may indirectly coat the electrode active material. The term “indirectly coat” means that a layer not containing the oxide solid electrolyte according to the present disclosure is disposed between the electrode active material and the coating layer. Even when the layer not containing the oxide solid electrolyte is disposed between the electrode active material and the coating layer in a part of the coated active material, when there is a portion where the electrode active material and the coating layer are in direct contact with each other, it is considered that the coating layer directly coats the electrode active material.

### 3. Coated Active Material

The coated active material according to the present disclosure is usually used for a battery. The electrode active material in the coated active material may be a positive electrode active material or a negative electrode active material, but the former is preferable. In addition, the method for producing the coated active material is not particularly limited, but a method described in “D. Method for Producing Coated Active Material” is preferable.

A shape of the coated active material is usually in a particulate form. An average particle diameter D₅₀ of the coated active material is, for example, 101 nm or more, and may be 1 μm or more or 5 μm or more. On the other hand, the average particle diameter D₅₀ of the electrode active material is, for example, 50 μm or less. The average particle diameter D₅₀ is as described above.

### C. Battery

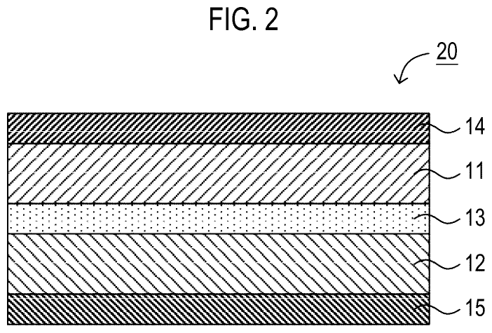

FIG. 2 is a schematic cross-sectional view illustrating the battery according to the present disclosure. A battery 20 shown in FIG. 2 includes a positive electrode active material layer 11, a negative electrode active material layer 12, an electrolyte layer 13 which is disposed between the positive electrode active material layer 11 and the negative electrode active material layer 12, a positive electrode current collector 14 which collects current of the positive electrode active material layer 11, and a negative electrode current collector 15 which collects current of the negative electrode active material layer 12. In the present disclosure, the positive electrode active material layer 11 or the negative electrode active material layer 12 contains the coated active material described in “B. Coated Active Material”.

Since the coated active material has suppressed deterioration and exhibits favorable ionic conductivity, the battery using the coated active material has favorable cycle characteristics. As described above, the coated active material may be a positive electrode active material or a negative electrode active material, but the former is preferable. Therefore, details of the battery will be described when the coated active material is the positive electrode active material, that is, when the positive electrode active material layer contains the coated active material.

### 1. Positive Electrode Active Material Layer

The positive electrode active material layer in the present disclosure contains the coated active material (positive electrode active material). The coated active material is the same as described in “B. Coated Active Material”, and thus the description thereof will be omitted.

In addition, the positive electrode active material layer may contain, as necessary, a conductive material, a binder, and an electrolyte. Examples of the conductive material include a carbon material, metal particles, and a conductive polymer. Examples of the carbon material include particulate carbon materials such as acetylene black (AB) and ketjen black (KB), and fibrous carbon materials such as carbon fibers, carbon nanotubes (CNT), and carbon nanofibers (CNF). In addition, examples of the binder include a rubber-based binder and a fluoride-based binder. The electrolyte is the same as described in “3. Electrolyte Layer”.

A thickness of the positive electrode active material layer is, for example, 0.1 μm or more and 1,000 μm or less, and may be 0.1 μm or more and 500 μm or less, or 0.1 μm or more and 100 μm or less. In addition, examples of a method for forming the positive electrode active material layer include a method of coating a positive electrode current collector with a positive electrode mixture containing the coated active material.

### 2. Negative Electrode Active Material Layer

The negative electrode active material layer is a layer containing at least a negative electrode active material. In addition, the negative electrode active material layer may contain, as necessary, at least one of an electrolyte, a conductive material, and a binder.

Examples of the negative electrode active material include a metal active material such as Li and Sn, am Si-based active material, a carbon active material such as graphite, and an oxide active material such as Li₄Ti₅O₁₂.

The negative electrode active material is preferably an Si-based active material. The reason is that the battery can be increased in capacity. The Si-based active material is an active material containing Si as a main component. The Si-based active material may be Si alone, an Si alloy, or an Si oxide. In addition, the Si-based active material may have a diamond crystalline phase, may have a clathrate type I crystalline phase, or may have a clathrate type II crystalline phase. In the clathrate type I or clathrate type II crystalline phase, a polyhedron (cage) including a pentagon or a hexagon is formed by a plurality of Si elements. The polyhedron has a space which can accommodate an Li ion inside, so that a volume change due to charging and discharging can be suppressed.

Examples of a shape of the negative electrode active material include a particle shape. An average particle diameter D₅₀ of the negative electrode active material is not particularly limited, and is, for example, 10 nm or more, and may be 100 nm or more. On the other hand, the average particle diameter D₅₀ of the negative electrode active material is, for example, 50 μm or less, and may be 20 μm or less.

The electrolyte used for the negative electrode active material layer is the same as described in “3. Electrolyte Layer”. In addition, the conductive material and the binder used for the negative electrode active material layer are the same as described in “1. Positive Electrode Active Material Layer”. A thickness of the negative electrode active material layer is, for example, 0.1 μm or more and 1,000 μm or less, and may be 0.1 μm or more and 500 μm or less, or 0.1 μm or more and 100 μm or less.

### 3. Electrolyte Layer

The electrolyte layer is a layer disposed between the positive electrode active material layer and the negative electrode active material layer, and contains at least an electrolyte. The electrolyte may be a solid electrolyte or a liquid electrolyte (electrolytic solution), but the former is preferable. In addition, the electrolyte layer may contain a binder as necessary. The binder is the same as described in “1. Positive Electrode Active Material Layer”.

As the solid electrolyte, for example, an inorganic solid electrolyte such as a sulfide solid electrolyte and an oxide solid electrolyte may be used. Among the electrolytes, it is preferable that the solid electrolyte is a sulfide solid electrolyte. The reason is that the ion conductivity is high.

The sulfide solid electrolyte usually contains at least an Li element and an S element. It is preferable that the sulfide solid electrolyte further contains an Me element (Me is at least one of P, As, Sb, Si, Ge, Sn, B, Al, Ga, and In). In addition, the sulfide solid electrolyte may contain a halogen element such as F, Cl, Br, and I.

The sulfide solid electrolyte may be a glass-based (amorphous) sulfide solid electrolyte, may be a glass-ceramic-based sulfide solid electrolyte, or may be a crystalline sulfide solid electrolyte. The sulfide solid electrolyte may have a crystalline phase. Examples of the crystalline phase include a Thio-LISICON-type crystalline phase, an argyrodite type crystalline phase, and an LGPS type crystalline phase.

A composition of the sulfide solid electrolyte is not particularly limited, and examples thereof include xLi₂S·(1−x)P₂S₅ (0.5≤x<1) and yLiI·zLiBr·(100−y−z)(xLi₂S·(1−x)P₂S₅) (0.5≤x<1, 0≤y≤30, 0≤z≤30). In the formulations, it is preferable to satisfy 0.7≤x≤0.8. In addition, examples of the formulation of the sulfide solid electrolyte also include Li_{7-x-2y}PS_{6-x-y}X_{y}. X is at least one of F, Cl, Br, and I, and x and y satisfy 0≤x and 0≤y. In addition, examples of the formulation of the sulfide solid electrolyte also include Li₄₋ₓMe₁₋ₓPₓS₄ (0<x<1). Me is at least one of Al, Zn, In, Ge, Si, Sn, Sb, Ga, and Bi.

A thickness of the electrolyte layer is, for example, 0.1 μm or more and 1,000 μm or less, and may be 0.1 μm or more and 500 μm or less, or 0.1 μm or more and 100 μm or less.

Here, generally, an electrolyte layer containing the inorganic solid electrolyte is referred to as a solid electrolyte layer, and a battery including the solid electrolyte layer is referred to as a solid-state battery. The solid-state battery may be a semi-solid-state battery or may be an all-solid-state battery. When the solid electrolyte layer in the solid-state battery contains solely the inorganic solid electrolyte as the electrolyte, the solid-state battery is referred to as an all-solid-state battery.

### 4. Other Configurations

The battery according to the present disclosure preferably includes a positive electrode current collector which collects current of the positive electrode active material layer and a negative electrode current collector which collects current of the negative electrode active material layer. Examples of a material of the positive electrode current collector include SUS, aluminum, nickel, iron, titanium, and carbon. On the other hand, examples of a material of the negative electrode current collector include SUS, copper, nickel, and carbon.

The battery according to the present disclosure may further include a restraining jig which applies a restraining pressure, along a thickness direction, to the positive electrode active material layer, the electrolyte layer, and the negative electrode active material layer. In particular, when the electrolyte layer is a solid electrolyte layer, it is preferable to apply a restraining pressure in order to form a favorable ion conduction path and electron conduction path. The restraining pressure is, for example, 0.1 MPa or more, and may be 1 MPa or more or 5 MPa or more. On the other hand, the restraining pressure is, for example, 100 MPa or less, and may be 50 MPa or less or 20 MPa or less.

### 5. Battery

A type of the battery according to the present disclosure is not particularly limited, but is typically a lithium ion battery. In addition, the battery according to the present disclosure is typically a solid-state battery including a solid electrolyte layer as an electrolyte layer. In particular, the battery according to the present disclosure is preferably an all-solid-state battery. In addition, the battery according to the present disclosure may be a primary battery or a secondary battery, but a secondary battery is preferable. The reason is that the all-solid state battery can be repeatedly charged and discharged, and is useful, for example, as a battery for a vehicle.

Examples of applications of the battery include a power source of a vehicle such as a hybrid electric vehicle (HEV), a plug-in hybrid electric vehicle (PHEV), a battery electric vehicle (BEV), a gasoline vehicle, and a diesel vehicle. In particular, the battery is preferably used as a drive power source for a hybrid electric vehicle (HEV), a plug-in hybrid electric vehicle (PHEV), or a battery electric vehicle (BEV). The battery may be used as a power source of a moving body other than the vehicle (for example, a train, a ship, or an airplane), or may be used as a power source of an electrical product such as an information processing device.

### D. Method for Producing Coated Active Material

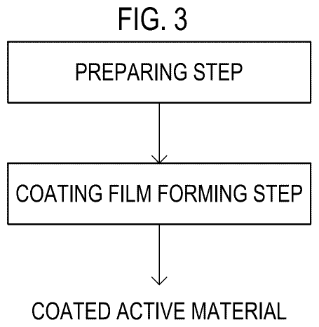

FIG. 3 is a flowchart illustrating the method for producing a coated active material according to the present disclosure. In the production method shown in FIG. 3, first, the oxide solid electrolyte is prepared (preparing step). Next, the electrode active material is coated with the oxide solid electrolyte by a dry process to form a coating layer (coating film forming step). As a result, a coated active material including an electrode active material and a coating layer which coats the electrode active material can be produced.

In the present disclosure, the oxide solid electrolyte can be prepared by firing a predetermined precursor of the oxide solid electrolyte at a temperature of 450° C. or lower. In addition, in the present disclosure, since the coating layer is formed by a dry process, the coated active material can be produced with suppressed influence of moisture, such as deterioration of the electrode active material.

### 1. Preparing Step

The preparing step is a step of preparing the solid electrolyte. The preparing step includes a precursor producing treatment of producing a powdery precursor containing an Li element, a B element, a P element, and an O element, and a firing treatment of firing the precursor at a temperature of 450° C. or lower. In addition, in the preparing step, an electrode active material may be prepared. The electrode active material is the same as described in “B. Coated Active Material”.

### (1) Precursor Producing Treatment

In the precursor producing treatment, a powdery precursor containing an Li element, a B element, a P element, and an O element is prepared.

In the precursor producing treatment, for example, a solute containing an Li source, a B source, a P source, and an O source is dissolved in a solvent to prepare a coating solution. Next, by drying the coating solution, a powdery precursor can be produced.

The Li source is not particularly limited as long as it is a single substance or a compound containing the Li element, and examples thereof include lithium hydroxide monohydrate (LiOH·H₂O). The B source is not particularly limited as long as it is a single substance or a compound containing the B element, and examples thereof include boric acid (H₃BO₃). The P source is not particularly limited as long as it is a single substance or a compound containing the P element, and examples thereof include orthophosphoric acid (H₃PO₄) and metaphosphoric acid (HPO₃). Examples of the O source include the O element contained in the B source or the P source. In additions, examples of the solvent include water. An amount of the Li source or the like is appropriately adjusted such that the oxide solid electrolyte according to the present disclosure can be obtained.

Specific examples of the method of producing the coating solution include a method of, first, producing a first aqueous solution in which orthophosphoric acid (H₃PO₄) or metaphosphoric acid (HPO₃) is dissolved in water, producing a second aqueous solution in which boric acid (H₃BO₃) is dissolved in the first aqueous solution, and then dissolving lithium hydroxide (LiOH) in the second aqueous solution to prepare the coating solution. A pH of the coating solution is not particularly limited, and is, for example, 6.0 or more and 9.0 or less. For example, when the amount of lithium hydroxide is too large so that the coating solution is to be strongly alkaline, there is a risk that a precipitate is generated or deviation in formulation occurs.

By drying the coating solution, a powdery precursor can be produced as coarse particles. The drying method is not particularly limited, and examples thereof include spray drying, an electric furnace, and a vacuum drying furnace.

In addition, in the precursor producing treatment, the coarse particles obtained by drying the coating solution may be pulverized. By pulverizing the coarse particles, an oxide solid electrolyte having a desired particle diameter can be produced. Examples of the pulverization method include mechanical milling such as bead milling and ball milling. The mechanical milling may be performed in a dry manner or in a wet manner. When the mechanical milling is performed in a wet manner, it is preferable to use a solvent other than water.

### (2) Firing Treatment

In the firing treatment, the precursor is fired at a temperature of 450° C. or lower.

In the production of the oxide solid electrolyte, it is assumed that firing at a high temperature, for example, 500° C. or higher is performed in order to increase crystallinity. On the other hand, in the method according to the present disclosure, the precursor is fired at a temperature of 450° C. or lower, which is relatively low. The detailed reason is not clear, but it is presumed that the three-coordinated B which is in a metastable phase is obtained by the presence of the Li element and the firing at a low temperature.

The firing temperature may be 400° C. or lower or may be 300° C. or lower. On the other hand, the firing temperature is, for example, 120° C. or higher, and may be 150° C. or higher or may be 200° C. or higher. The firing time is not particularly limited, and is, for example, 30 minutes or longer and 20 hours or shorter. The firing atmosphere is not particularly limited, and examples thereof include an atmospheric atmosphere. In addition, the firing atmosphere may be an atmosphere in which a dew point is controlled. The dew point is not particularly limited, and is, for example, −20° C. or lower.

### 2. Coating Film Forming Step

The coating film forming step is a step of coating the electrode active material with the oxide solid electrolyte by a dry process to form a coating layer.

Examples of the dry process include a method of subjecting a mixture containing the electrode active material and the oxide solid electrolyte to a shearing treatment. The mixture basically does not contain water, but may contain a small amount of water which can be ignored. The shearing treatment is, for example, a treatment of rotating a chopper disposed in a container. Examples of the shearing treatment also include a method of rotating a blade disposed in a container to apply compressive shearing energy to the mixture present between the blade and a wall surface of the container. In addition, conditions of the shearing treatment are not particularly limited, and it is preferable to appropriately adjust the conditions such that the coated active material described in “B. Coated Active Material” is obtained.

### 3. Coated Active Material

The coated active material obtained in each of the steps is not particularly limited, but is preferably the coated active material described in “B. Coated Active Material”.

The present disclosure is not limited to the embodiments. The embodiments are examples, and anything that has substantially the same configuration as the technical idea described in the claims of the present disclosure and produces the same effect is included in the technical scope of the present disclosure.

### Example 1

Metaphosphoric acid (manufactured by FUJIFILM Wako Pure Chemical Corporation) and ion-exchanged water were mixed with each other at a ratio of 4.52:191.8 (weight ratio) to prepare an aqueous solution. Boric acid (manufactured by NACALAI TESQUE, INC.) as a B source was added to the aqueous solution to be dissolved. The boric acid was added in an amount such that a proportion (molar ratio) of the B element with respect to the P element was 1.0. Furthermore, lithium hydroxide monohydrate (manufactured by FUJIFILM Wako Pure Chemical Corporation) as an Li source was added thereto to be dissolved. The lithium hydroxide monohydrate was added in an amount such that a proportion (molar ratio) of the Li element with respect to the total of the B element and the P element was 0.1. As a result, a precursor solution was produced.

The precursor solution was dried using a spray dryer to obtain a white powder as a precursor. The obtained precursor was heat-treated in air at 230° C. for 5 hours under a condition in which a dew point was controlled to be lower than −30° C. As a result, an oxide solid electrolyte (LBPO) was obtained.

### Examples 2 and 3

An oxide solid electrolyte was produced in the same manner as in Example 1, except that the lithium hydroxide monohydrate was added in an amount such that a proportion (molar ratio) of the Li element with respect to the total of the B element and the P element was 0.5 or 0.9.

### Comparative Example 1

As an oxide solid electrolyte, an electrolyte not containing the Li element (BPO₄; manufactured by Yoneyama Chemical Industry Co., Ltd.) was prepared.

### Comparative Example 2

An oxide solid electrolyte (Li-doped BPO₄; LBPO) in which a proportion (molar ratio) of the Li element with respect to the total of the B element and the P element was 0.5 was produced based on the descriptions of Academic Paper 1 (Journal of Solid State Chemistry 142, 74-79 (1999)) and Academic Paper 2 (A. J. Dodd, E. R. H. van Eck/Chemical Physics Letters 365 (2002), 313-319). As the B element source, boric acid (manufactured by Aldrich) was used; as the P element source, orthophosphoric acid (manufactured by Kishida Chemical Co., Ltd.) was used; and as the Li element source, lithium hydroxide monohydrate (manufactured by FUJIFILM Wako Pure Chemical Corporation) was used. In addition, the firing conditions were set to 500° C. for 6 hours in air in which a dew point was controlled to be lower than −30° C. In the academic papers, it is described that phosphorus pentoxide (P₂O₅) is used as the P element source; however, since the phosphorus pentoxide changes to orthophosphoric acid by mixing with water, the starting material is the same.

### Comparative Example 3

Hydrogen peroxide water (mass concentration: 30%), ion exchange water, and niobic acid (Nb₂O₅·3H₂O) were charged into a container. Aqueous ammonia (mass concentration: 28%) was further added to the container. In addition, lithium hydroxide monohydrate was added to the container. The container was stirred to obtain a solution containing an Li element, an Nb element, and an O element. In the solution, it is presumed that the Nb element was present as a peroxo complex. The solution was dried using a spray dryer to obtain a white powder. The obtained powder was heat-treated under conditions of 200° C. and 5 hours in an air atmosphere. As a result, an oxide solid electrolyte (LiNbO₃) was obtained.

### Evaluation 1

### ICP Analysis

The solid electrolytes of Examples 1 to 3 and Comparative Examples 1 and 3 were subjected to elemental analysis by an ICP emission analysis method. First, 0.01 g of the solid electrolyte was added to concentrated hydrochloric acid, and the mixture was boiled to dissolve the solid electrolyte, thereby preparing an evaluation sample. In addition, 0.01 g of a standard solution (1,000 ppm and 10,000 ppm) for Li, B, and P was diluted with pure water to prepare a standard sample. A calibration curve was created by measuring the standard sample, and the evaluation sample was measured based on the calibration curve to calculate a mass concentration of each element. Next, the element ratios (molar ratios) of Li, P, and B were calculated from the mass concentrations. As a measurement device, ICPR-9800 manufactured by Shimadzu Corporation was used. The results are shown in Table 1.

As shown in Table 1, it was found that, in Examples 1 to 3, the oxide solid electrolyte could be synthesized without deviation in formulation. As shown in Table 1, an Na element was detected in the ICP analysis. The element is considered to be derived from an additive contained in the commercially available metaphosphoric acid.

TABLE 1

| | | Chemical formulation | | |
|---|---|---|---|---|
| | Firing temperature | Li/(B + P) | B/P | Na/P |
| Comparative | — | 0 | 1.1 | 0 |
| Example 1 | | | | |
| Comparative | 500° C. | — | — | — |
| Example 2 | | | | |
| Comparative | 200° C. | — | — | — |
| Example 3 | | | | |
| Example 1 | 230° C. | 0.12 | 1.0 | 0.49 |
| Example 2 | 230° C. | 0.52 | 1.0 | 0.51 |
| Example 3 | 230° C. | 0.91 | 1.1 | 0.51 |

### Measurement of Particle Size Distribution

An average particle diameter (D₅₀) of the oxide solid electrolytes of Comparative Examples 1 and 3 and Examples 1 to 3 was measured using a device (Aerotrac II) manufactured by MicrotracBEL Corp. The results are shown in Table 2.

As shown in Table 2, the average particle diameter of the synthesized oxide solid electrolyte was smaller than that of the commercial product.

### XRD Measurement

XRD measurement was performed on the oxide solid electrolytes of Comparative Examples 1 and 3 and Examples 1 to 3 using a device (Smartlab) manufactured by Rigaku Holdings Corporation. A line source was Cu, and a scan range was from 10° to 90°. The presence or absence of a crystalline phase was confirmed from the obtained diffraction chart, and the crystalline phase was identified. The results are shown in Table 2.

As shown in Table 1 and Table 2, in Comparative Example 3 and Examples 1 and 2, in which the firing temperature was low, the crystalline phase could not be confirmed. On the other hand, as shown in Example 3, it was found that, by sufficiently increasing the proportion of Li, the crystallinity was increased even when the firing temperature was low.

### NMR Measurement

NMR measurement (solid ¹¹B-NMR) was performed on the ¹¹B core. As a measurement device, ECA-500 manufactured by JEOL Ltd., which is a Fourier transform nuclear magnetic resonance device (FT-NMR device), was used. Measurement conditions were set to a single pulse mode, a repetition time of 60 sec, an integration number of 8 times, and a rotation speed of 18 kHz. The presence or absence of the three-coordinated B and the four-coordinated B was confirmed from the obtained chart. Next, the Sa/(Sa+Sb) was calculated from the peak area (Sa) of the three-coordinated B and the peak area (Sb) of the four-coordinated B. The results are shown in Table 2.

As shown in Table 2, the three-coordinated B was not confirmed in Comparative Examples 1 and 2. In addition, in Academic Papers 1 and 2 regarding Comparative Example 2, it was described that the three-coordinated B was not confirmed (page 77 of Academic Paper 1, page 316 of Academic Paper 2).

### Measurement of Ionic Conductivity and Evaluation of Chemical Stability

The solid electrolytes in Examples and Comparative Examples were each interposed between aluminum foils coated with carbon, and uniaxially pressed at a pressure of 2 t for 120 seconds. As a result, an evaluation sample was prepared. Each evaluation sample was installed in a constant temperature bath at 25° C., and alternating current impedance measurement was performed. The ionic conductivity (lithium ionic conductivity at 25° C.) was calculated from the obtained size of the arc. The results are shown in Table 2.

The chemical stability was evaluated by performing CV measurement (oxidation current measurement). Specifically, the solid electrolytes in Examples and Comparative Examples were each mixed with acetylene black at a volume ratio of 1:1 to prepare a mixture powder. The mixture powder was used as a working electrode, a layer of a sulfide solid electrolyte (10LiI-15LiBr-75Li₃PS₄) was used as a separator layer, and an Li—In alloy was used as a counter electrode, thereby producing an evaluation cell. The evaluation cell was installed in a constant temperature bath at 25° C., a potential was scanned at 0.1 mV/sec in a voltage range from 1.9 V to 4.4 V, and an oxidation current amount was measured. Oxidation current amounts in the second cycle were integrated, and the area was calculated. The chemical stability was evaluated depending on the size of the area. As the chemical stability is lower, the integrated area is larger. The results are shown in Table 2.

As shown in Table 2, in Comparative Example 1, the chemical stability was favorable, but the ionic conductivity was low. In addition, in Comparative Example 3, the ionic conductivity was favorable, but the chemical stability was low. On the other hand, in Examples 1 to 3, both the ionic conductivity and the chemical stability were favorable. From the above, it was found that the oxide solid electrolyte according to the present disclosure exhibited favorable chemical stability and had favorable ionic conductivity.

TABLE 2

| | | | | Ionic | CV |
|---|---|---|---|---|---|
| | D₅₀ | Crystalline | Sa/(Sa + | conductivity | integrated |
| | (μm) | phase | Sb) | (S/cm) | area |
| Comparative | 22.7 | BPO₄ | 0 | 7.29 × 10⁻¹¹ | 0.23 |
| Example 1 | | | | | |
| Comparative | — | — | 0 | 1.26 × 10⁻⁹ | 1.59 |
| Example 2 | | | | | |
| Comparative | 4.0 | None | — | 1.87 × 10⁻⁷ | 1.89 |
| Example 3 | | | | | |
| Example 1 | 4.7 | None | 0.03 | 2.13 × 10⁻⁹ | 0.15 |
| Example 2 | 7.3 | None | 0.17 | 1.76 × 10⁻⁹ | 0.16 |
| Example 3 | 3.5 | Li₃PO₄ | 0.37 | 1.64 × 10⁻⁹ | 0.28 |

### Comparative Example 4

Metaphosphoric acid and boric acid were mixed with each other, and fired in air at 230° C. for 5 hours in a state in which the dew point was controlled to be lower than −30° C. As a result, as the oxide solid electrolyte, an electrolyte (BPO₄) not containing the Li element was synthesized.

### Comparative Example 5

BPO₄ was synthesized in the same manner as in Comparative Example 4, except that the firing temperature was changed to 120° C.

### Evaluation 2

### NMR Measurement

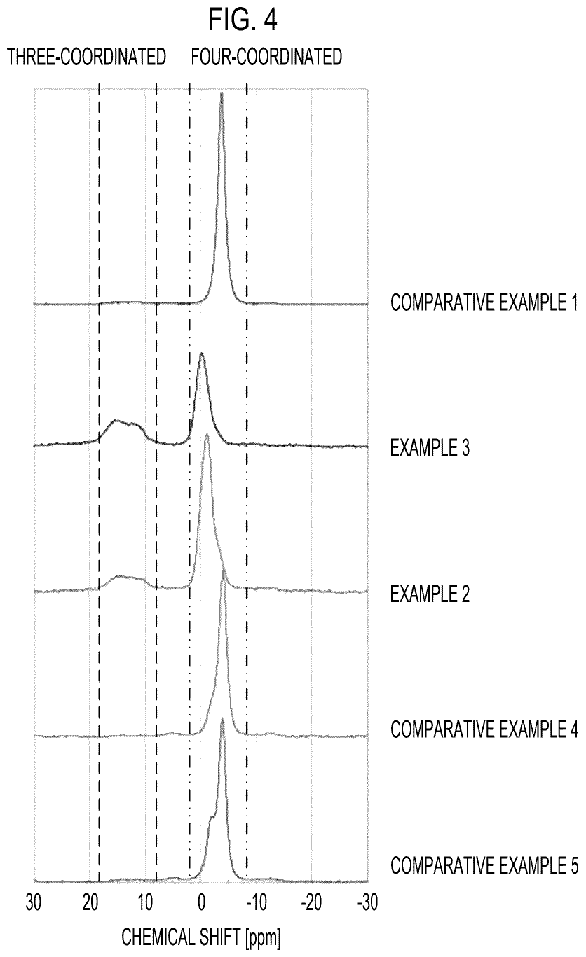

Solid 11B-NMR measurement was performed on the BPO₄ of Comparative Example 4 and Comparative Example 5 in the same manner as in Evaluation 1. The results of Examples 2 and 3 and Comparative Example 1 are shown in FIG. 4.

As shown in FIG. 4, it was found that, even when the firing temperature was low, the three-coordinated B could not be obtained in the absence of the Li element.

### Example 4

An oxide solid electrolyte was synthesized in the same manner as in Example 3, except that the firing temperature was changed to 450° C.

### Evaluation 3

### NMR Measurement

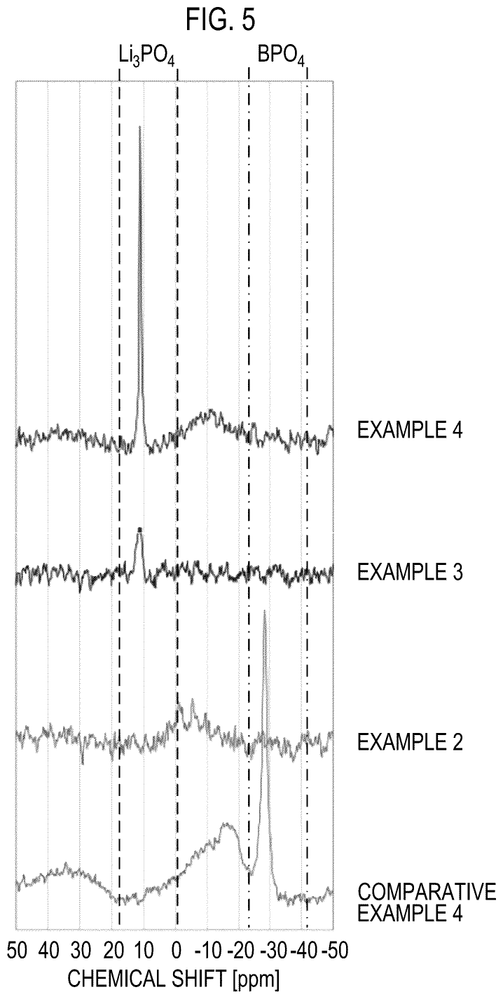

The oxide solid electrolytes of Examples 2 to 4 and Comparative Example 4 were each subjected to solid ³¹P-NMR, and the analysis of the P element in the oxide solid electrolyte was performed. The results are shown in FIG. 5.

As shown in FIG. 5, a peak of the P element derived from Li₃PO₄ was confirmed as the firing temperature was increased. It was found that the crystallinity was increased by increasing the firing temperature, in combination with the XRD measurement results shown in Table 2.

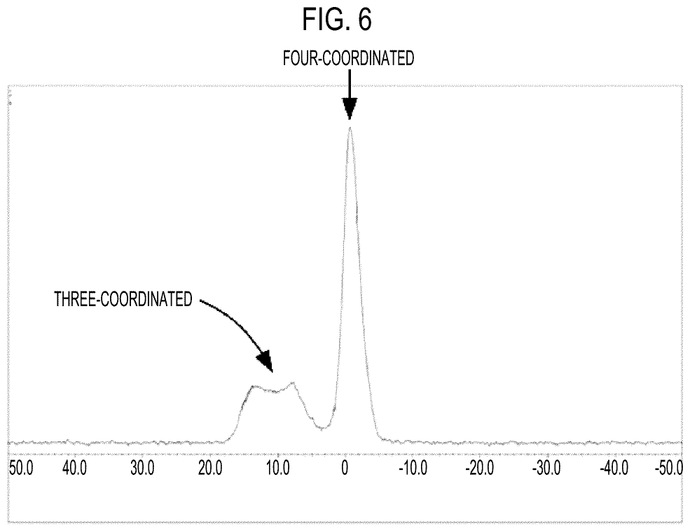

In addition, when the oxide solid electrolyte of Example 4 was also subjected to the solid ¹¹B-NMR measurement, as shown in FIG. 6, a peak of the three-coordinated B and a peak of the four-coordinated B were confirmed as in Example 3.

What is claimed is:

1. An oxide solid electrolyte containing an Li element, a B element, a P element, and an O element, the oxide solid electrolyte comprising a three-coordinated boron having a coordination number of three.

2. The oxide solid electrolyte according to claim 1, wherein:
the oxide solid electrolyte contains a four-coordinated boron having a coordination number of four; and
when a peak area of the three-coordinated boron is denoted by Sa and a peak area of the four-coordinated boron is denoted by Sb, the peak areas being obtained by NMR measurement of the oxide solid electrolyte, a proportion Sa/(Sa+Sb) of the peak area Sa with respect to a sum of the peak area Sa and the peak area Sb is 1% or more.

3. The oxide solid electrolyte according to claim 2, wherein the proportion Sa/(Sa+Sb) is 45% or less.

4. The oxide solid electrolyte according to claim 3, wherein the proportion Sa/(Sa+Sb) is 3% or more and 37% or less.

5. The oxide solid electrolyte according to claim 1, wherein a proportion Li/(B+P) of the Li element with respect to a total of the B element and the P element is 0.10 or more and 1.20 or less.

6. The oxide solid electrolyte according to claim 1, wherein an ionic conductivity at 25° C. is 1.50×10⁻⁹ S/cm or more.

7. The oxide solid electrolyte according to claim 1, wherein an average particle diameter D₅₀ of the oxide solid electrolyte is 3.0 μm or more and 8.0 μm or less.

8. A coated active material comprising:
an electrode active material; and
a coating layer which coats the electrode active material, wherein:
the coating layer contains the oxide solid electrolyte according to claim 1.

9. The coated active material according to claim 8, wherein the electrode active material is an oxide active material.

10. The coated active material according to claim 9, wherein the oxide active material is at least one of lithium nickel cobalt aluminum oxide, lithium nickel cobalt manganese oxide, and lithium nickel cobalt manganese aluminum oxide.

11. The coated active material according to claim 8, wherein:
the electrode active material includes a negative electrode active material;
the negative electrode active material is an Si-based active material; and
the Si-based active material has a clathrate type I crystalline phase or a clathrate type II crystalline phase.

12. A battery comprising:
a positive electrode active material layer;
a negative electrode active material layer; and
an electrolyte layer disposed between the positive electrode active material layer and the negative electrode active material layer, wherein:
at least one of the positive electrode active material layer and the negative electrode active material layer contains a coated active material including an electrode active material and a coating layer which coats the electrode active material; and
the coating layer contains the oxide solid electrolyte according to claim 1.

13. The battery according to claim 12, wherein the positive electrode active material layer contains the coated active material.

14. The battery according to claim 12, wherein the battery is a solid-state battery.

15. A method for producing a coated active material including an electrode active material and a coating layer which coats the electrode active material, the method comprising:
preparing the oxide solid electrolyte according to claim 1; and
forming the coating layer by coating the electrode active material with the oxide solid electrolyte by a dry process, wherein:
the preparing includes a precursor producing treatment of producing a powdery precursor of the oxide solid electrolyte containing an Li element, a B element, a P element, and an O element, and a firing treatment of firing the precursor at a temperature of 450° C. or lower.

16. The method according to claim 15, wherein in the firing treatment, the precursor is fired at a temperature of 120° C. or higher.
